(19) United States
(12) Patent Application Publication
(10) Pub. No.: US 2014/0335741 A1
(43) Pub. Date: Nov. 13, 2014

(54) CONNECTION TERMINAL AND CONNECTION TERMINAL MANUFACTURING METHOD

(71) Applicant: YAZAKI CORPORATION, Minato-ku, Tokyo (JP)

(72) Inventor: Ryosuke Uno, Makinohara-shi (JP)

(21) Appl. No.: 14/361,871

(22) PCT Filed: Nov. 29, 2012
(86) PCT No.: PCT/JP2012/080904

§ 371 Date: May 30, 2014

(30) Foreign Application Priority Data
Dec. 1, 2011 (JP) 2011-263270

(51) Int. Cl. H01R 13/405; H01R 13/58

(52) U.S. Cl. CPC H01R 13/405; H01R 13/5808
USPC 439/736

(57) ABSTRACT

A connection terminal (1) includes a terminal connection part (2) having a casing part (3) into which a mating terminal is to be inserted, a wire connection part (10) to which a wire (W) is connected, and a neck part (20) which couples the terminal connection part (2) and the wire connection part (10). A connection site of the wire connection part (10) and the wire (W) are covered with a resin covering part (30). The terminal connection part (2) is provided with a closing partition (5) which closes off an interior of the casing part (3) on the side of the neck part (20). The neck part (20) includes a bottom face wall (21) and lateral face walls (22) standing from either side of the bottom face wall (21). The lateral face walls (20) have parallel wall parts (22a) with a uniform spacing between the parallel wall parts.

### TECHNICAL FIELD

The present invention relates to a connection terminal where a connection site between a wire connection part and a wire is covered with a resin covering part and a manufacturing method of the connection terminal.

### BACKGROUND ART

Hitherto, there are a variety of proposals related to a connection terminal where a connection site between a wire connection part and a wire is covered with a resin covering part (see PTL 1 and PTL 2). One convention example of such a connection terminal is illustrated in FIGS. 1 to 3.

As illustrated in FIGS. 1 and 2, a conventional connection terminal 100 includes a terminal connection part 101 to which a mating terminal is to be connected, a wire connection part 110 to which a wire W is connected, and a neck part 120 which couples the terminal connection part 101 and the wire connection part 120. The terminal connection part 101, the wire connection part 110, and the neck part 120 are formed by bending a piece of conductive metal plate.

The terminal connection part 101 is shaped to have a square-tubular configuration. The mating terminal is inserted into the square-tubular configuration. The wire connection part 110 has a U-shaped enclosure wall 111. A pair of first wire crimping parts 113 and a pair of second wire crimping parts 114 are formed so as to project from respective top end faces of the enclosure wall 111 on both sides thereof. The first wire crimping parts 113 are crimped to a core wire 150 of the wire W. The second wire crimping parts 114 are crimped to a wire's site covered with a covering rind 151.

The neck part 120 includes a bottom face wall 121 and a pair of lateral face walls 122 standing from either side of the bottom face wall 121. The bottom face wall 121 and the lateral face walls 122 are formed in succession to respective walls of both the terminal connection part 101 and the wire connection part 110. The pair of lateral face walls 122 are inclined so as to gradually narrow an interval therebetween as directing from the terminal connection part 101 toward the wire connection part 110. The width dimension of the terminal connection part 101 is constricted to the width dimension of the wire connection part 110 through the neck part 120.

A connection site between the wire connection part 110 and the wire W is covered with a resin covering part 130. The resin covering part 130 is produced by injection molding of resin.

That is, as illustrated in FIG. 3, the connection terminal 100 with the connected wire W is set in a die 140 for resin molding. The die 140 consists of an upper die 141 and a lower die (not illustrated). FIG. 3 illustrates the connection terminal 100 being set in the lower die 141. Next, resin is cast into a cavity 141a of the lower die 141 and also a cavity (not illustrated) in the upper die (not illustrated), completing the resin covering part 130 as a result of solidification of cast resin.

Here, when molding resin, an insert die part 142 (illustrated with imaginary lines of FIG. 2) of the die 140 gets into the neck part 120. Both lateral faces of the insert die part 142 are formed of inclined faces corresponding to the lateral face walls 122. The insert die part 142 dams up molten resin so that it does not flow from the wire connection part 110 side into the terminal connection part 101 side.

In the conventional example mentioned above, if the connection terminal 100 and the core wire 150 of the wire W are made of different metallic materials (for example, the connection terminal 100 made of copper and the wire W made of aluminum), invasion of water etc. into the connection site between the connection terminal and the wire may cause corrosion due to a potential difference produced therebetween. Therefore, the resin covering part 130 is provided to avoid such an invasion.

### CITATION LIST

### Patent Literature

PTL 1: JP 2010-097704 A
PTL 2: JP 2010-135121 A

### SUMMARY OF INVENTION

In the connection terminal 100 of the conventional example where the pair of lateral face walls 122 of the neck part 120 are inclined, however, if the insert die part 142 is positioned out of a predetermined position on the terminal connection part 101 side, then a gap d is produced between the insert die part 142 and each lateral face wall 122 as illustrated in FIG. 4(a), making it impossible for the insert die part to dam up the molten resin certainly. Such a flow-in of molten resin to the terminal connection part 101 may cause poor contacting.

Meanwhile, if insert die part 142 is positioned out of the predetermined position on the wire connection part 110 side as illustrated in FIG. 4(b), then the insert die part 142 abuts against respective top end faces of the lateral face walls 122, precluding a normal setting of the insert die part 142. Then, the insert die part 142 or the lateral face walls 122 may be subjected to damage or the like. Thus, it has been required to manage the positioning of the insert die part 142 with high accuracy.

In order to solve the above-mentioned problem, therefore, an object of the present invention is to provide a connection terminal which eliminates the need of preventing the inflow of molten resin into a terminal connection part by a molding die in resin molding and which facilitates the positional management of the molding die.

According to a first aspect of the present invention, a connection terminal includes a terminal connection part having a casing part into which a mating terminal is to be inserted, a wire connection part to which a wire is connected, and a neck part which couples the terminal connection part and the wire connection part. A connection site between the wire connection part and the wire is covered with a resin covering part. The terminal connection part is provided with a closing partition which closes off an interior of the casing part on the side of the neck part. The neck part includes a bottom face wall and a pair of lateral face walls standing from either side of the bottom face wall. The pair of lateral face walls have parallel wall parts with a uniform spacing therebetween.

The closing partition may be provided by folding an inside top face wall, which is an inside one of two pieces of top face walls folded to overlap with each other, downwardly at a rear end of the inside top face wall.

According to a second aspect of the present invention, there is provided a manufacturing method of manufacturing the connection terminal according to the first aspect of the invention, wherein getting an insert die part provided in the die to dam up resin into an inside of the pair of parallel wall parts when molding the resin covering part, pouring resin into a cavity inside the die, and forming the resin covering part by solidification of the poured resin.

According to the aspects of the present invention, when molding the resin covering part with resin, the inflow of molten resin into the casing part of the terminal connection part is prevented by the closing partition. Therefore, when molding the resin covering part with resin, there is no need of allowing the die to prevent the inflow of molten resin into the terminal connection part, so that the positional management of the die is facilitated. Additionally, the inflow of molten resin into the terminal connection part can be also prevented by allowing the insert die part of the die to get into the inside of the pair of parallel wall parts, certainly.

### BRIEF DESCRIPTION OF DRAWINGS

FIG. 1 is a perspective view of a connection terminal according to a conventional example.

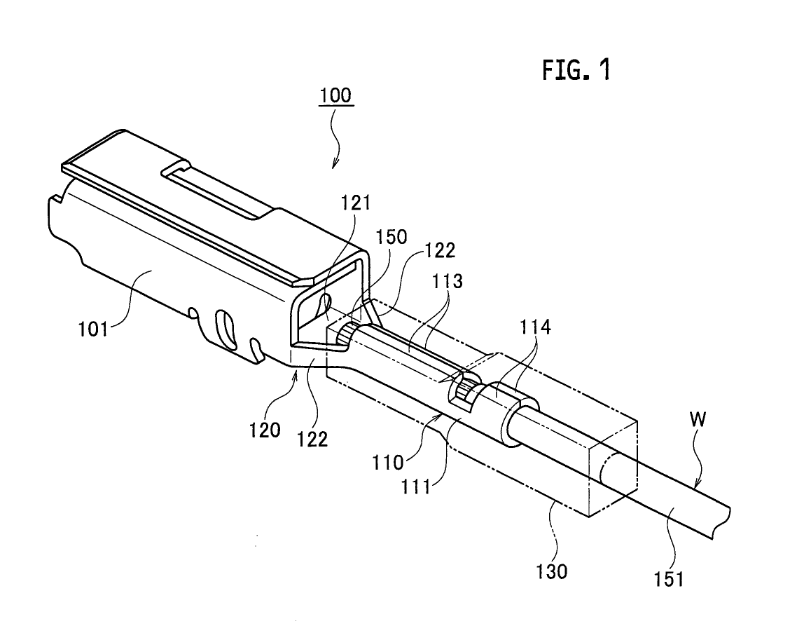

FIG. 2 is a plan view of a connection terminal body before connecting a wire, in the connection terminal according to the conventional example.

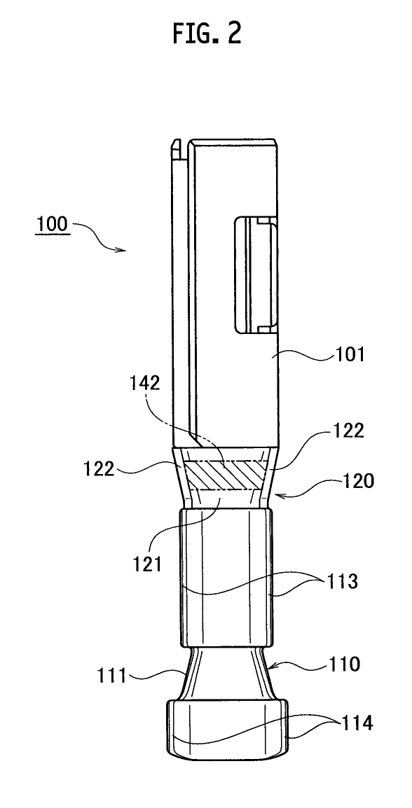

FIG. 3 is a plan view of the connection terminal according to the conventional example, illustrating a state that the connection terminal is set in a lower die for resin molding.

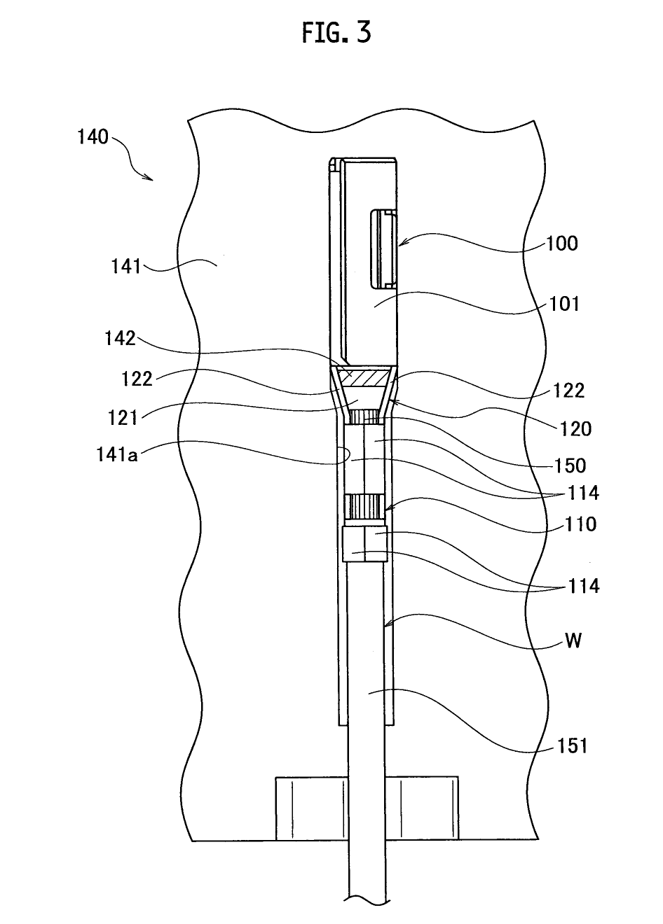

FIG. 4(a) is a plan view illustrating a situation where an insert die part of a die is positionally shifted to the terminal connection part side in the connection terminal of the conventional example, and FIG. 4(b) is a plan view illustrating a situation where the insert die part of the die is positionally shifted to the wire connection part side in the connection terminal of the conventional example.

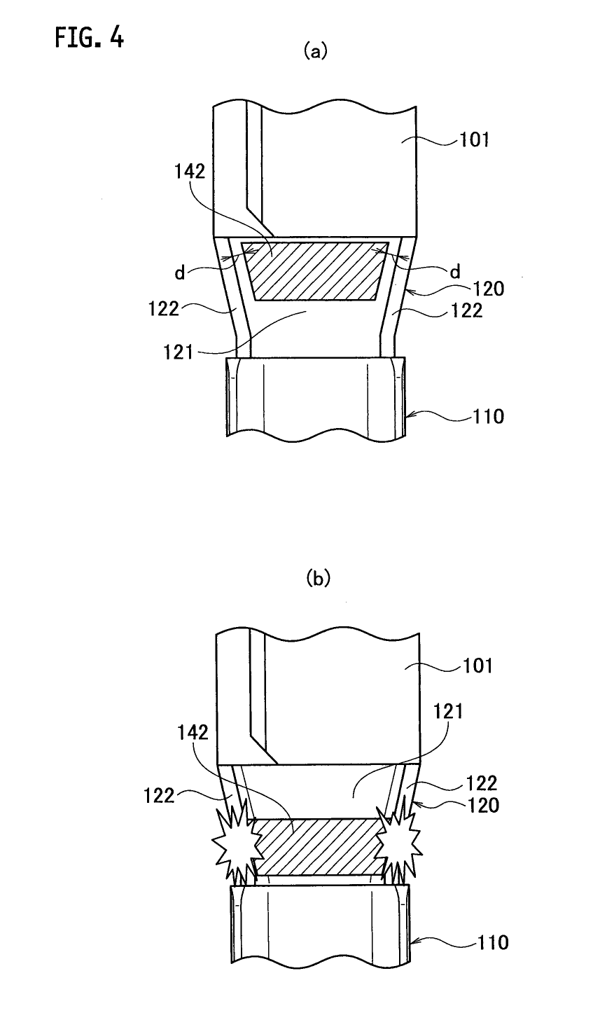

FIG. 5 is a perspective view of a connection terminal according to an embodiment of the present invention.

FIG. 6(a) is a side view of the connection terminal of the embodiment of the present invention, and FIG. 6(b) is a sectional view taken along a line A-A of FIG. 6(a).

FIG. 7(a) is a front view illustrating a situation before covering the connection terminal of the embodiment of the present invention with resin, and FIG. 7(b) is a sectional view taken along a line B-B of FIG. 7(a).

FIG. 8 is a development view of the connection terminal of the embodiment of the present invention.

FIG. 9 is a sectional view illustrating a situation where the connection terminal of the embodiment of the present invention is set in a die for resin molding.

### DESCRIPTION OF EMBODIMENTS

An embodiment of the present invention will be described with reference to drawings, below.

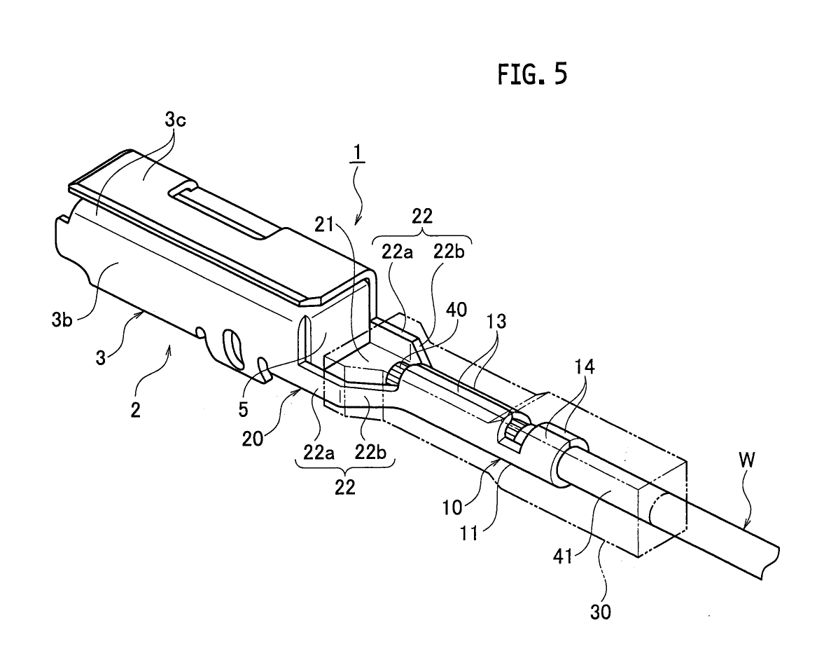

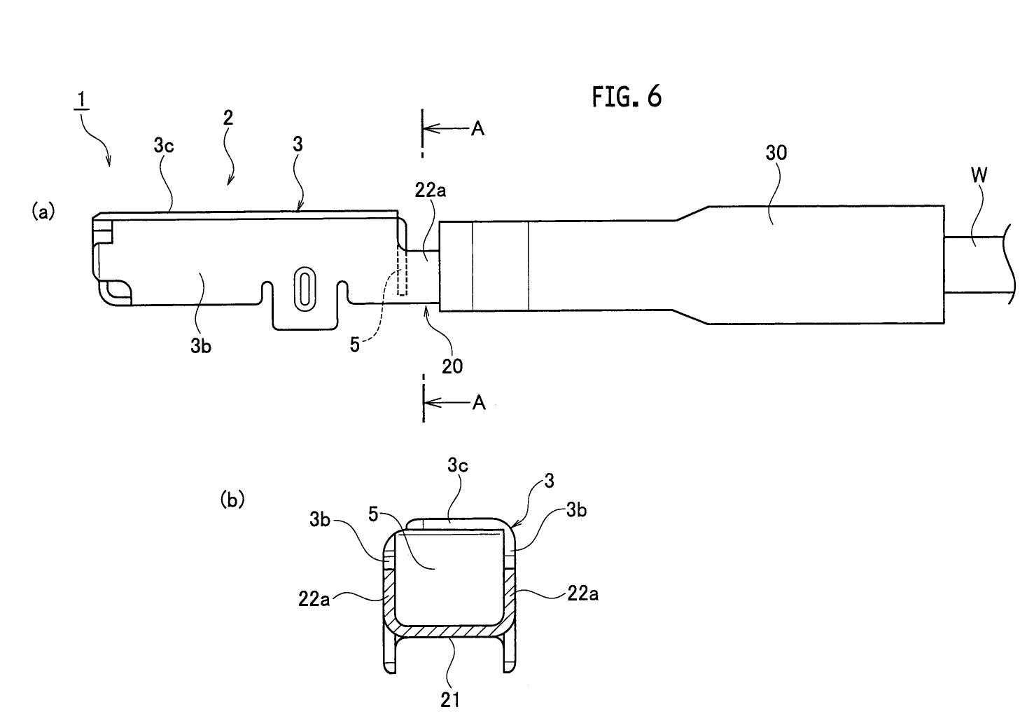

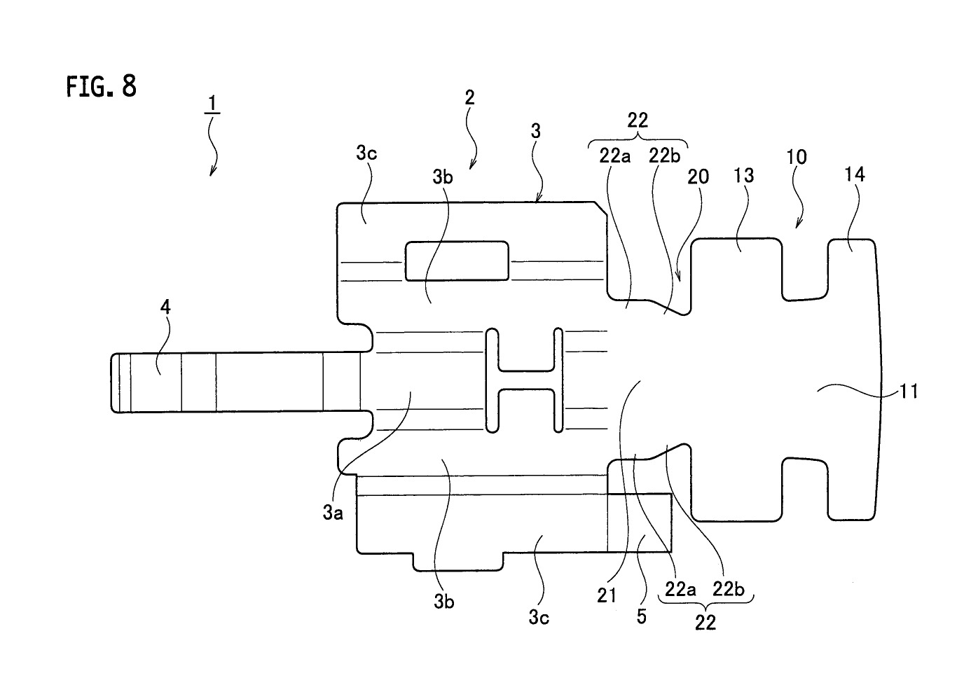

FIGS. 5 to 9 illustrate the embodiment of the present invention. As illustrated in FIGS. 5 and 6, a connection terminal 1 according to the embodiment includes a terminal connection part 2 to which a mating terminal (not illustrated) is to be connected, a wire connection part 10 to which a wire W is connected and a neck part 20 which couples the terminal connection part 2 and the wire connection part 10. The terminal connection part 2, the wire connection part 10, and the neck part 20 are formed by bending a copper alloy plate as a conductive metal plate having a configuration form illustrated in FIG. 8.

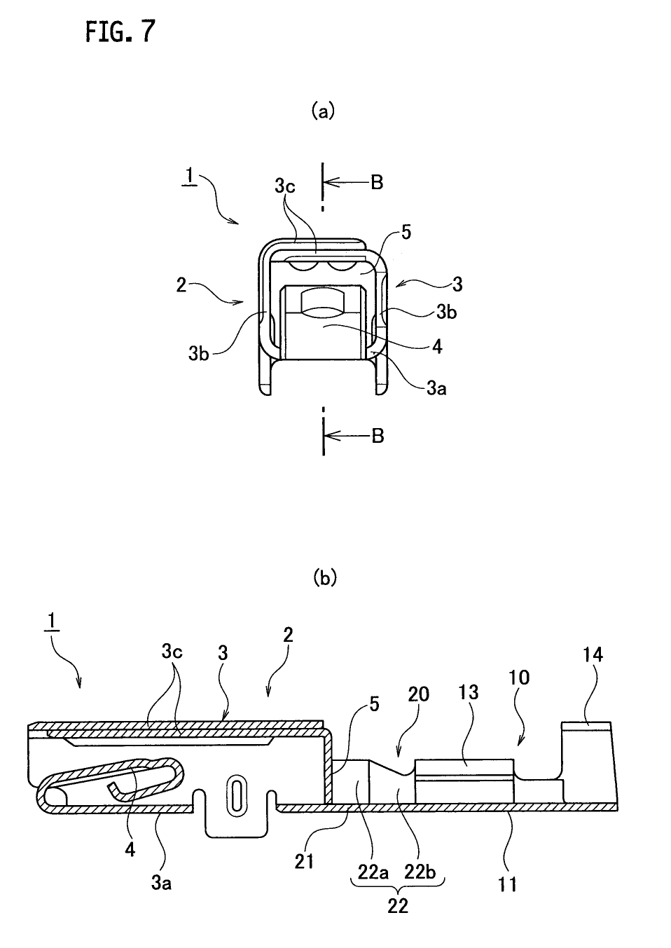

The terminal connection part 2 has a casing part 3 having a square cross section, and an elastic contact piece 4 (see FIGS. 7(a) and 7(b)). The casing part 3 includes a bottom face wall 3a, a pair of lateral face walls 3b folded from both lateral edges of the bottom face wall 3a upwardly, and two pieces of top face walls 3c folded from both top ends of the lateral face walls 3b horizontally so as to overlap each other. Formed integrally with the casing part 3 is a closing partition (wall) 5 which extends from a rear end of the inside top face wall 3c. The closing partition 5 is folded downwardly at the rear end of the inside top face wall 3c. With this constitution, the closing partition 5 closes off an interior of the casing part 3 on the side of the neck part 20 as well as enabling a certain positioning of two top face walls 3c.

When the mating terminal is inserted into the casing part 3, the mating terminal is attached firmly to the casing part 3 due to flexible recovery force of the elastic contact piece 4, effecting the electrical connection between the casing part 3 and the mating terminal.

The wire connection part 10 has a U-shaped enclosure wall 11. A pair of first wire crimping parts 13 and a pair of second wire crimping parts 14 are formed so as to project from respective top end faces of the enclosure wall 11 on both sides thereof. The pair of first wire crimping parts 13 are crimped to a core wire 40 exposed out of the wire W. The pair of second wire crimping parts 14 are crimped to a wire's site covered with an insulating rind 41 of the wire W. The core wire 40 of the wire W is made from aluminum material.

The neck part 20 includes a bottom face wall 21 and a pair of lateral face walls 22 standing from either side of the bottom face wall 21. The bottom face wall 21 and the pair of lateral face walls 22 are formed in succession to respective walls of both the terminal connection part 2 and the wire connection part 10.

The pair of lateral face walls 22 include parallel wall parts 22a with a uniform spacing therebetween and inclined wall parts 22b with a changing spacing therebetween. Owing to the provision of the pair of inclined wall parts 22b, the width dimension of the terminal connection part 2 is constricted to the width dimension of the wire connection part 10.

The connection site of the wire connection part 10 and the wire W is covered with a resin covering part 30. The resin covering part 30 covers the periphery of the wire connection part 10 and the periphery of a terminal part of the wire W completely. Corrosion, which originates in the infiltration of water etc. into the connection site of the wire connection part 10 and the wire W, is prevented by the resin covering part 30. The resin covering part 30 is manufactured by resin injection molding using a die 60, as will be described later.

Next, the manufacturing procedure of the connection terminal 1 will be described. First, a copper alloy plate having a profile of FIG. 8 is prepared and subsequently, pressure molding or the like is applied to this plate, manufacturing the connection terminal 1. Next, a wire connection process to connect the connection terminal 1 with the terminal part of the wire W is performed. The wire connection process is carried out with use of a wire crimping device (not illustrated).

Next, the resin molding process is performed with the die 60. First, the constitution of the die 60 will be described. The die 60 includes a lower die 61 and an upper die 62. The upper die 62 includes an insert die part 63 in a position corresponding to the pair of parallel wall parts 22a of the neck part 20. The insert die part 63 of the upper die 62 is established with a dimension by which the insert die part 63 can be inserted inside the pair of parallel wall parts 22a of the connection terminal 1 while leaving no space. Different from the conventional example, both lateral faces of the insert die part 63 are established in parallel with each other, corresponding to the pair of parallel wall parts 22a. With this constitution, even when the insert die part 63 is set, inside the pair of parallel wall parts 22a, in a position somewhat shifted from the predetermined position to either the terminal connection part 2 side or the closing partition 5 side, there is no possibility that any gap is produced between the insert die part 63 and the parallel wall parts 22a or that the insert die part 63 abuts against the parallel wall parts 22a. Therefore, the positioning management of the die 60 is facilitated.

The insert die part 63 presses the bottom face wall 21 of the neck part 20 to maintain the connection terminal 1 in an appropriate position. The die 60 includes a wire holding part 64 by which the wire W can be pinched in the vertical direction and also maintained in an appropriate position. That is, the die 60 holds the wire W in the appropriate position through the wire holding part 64 and also hold the connection terminal 1 through the insert die part 63. The resin molding is performed with use of the above-constructed die 60.

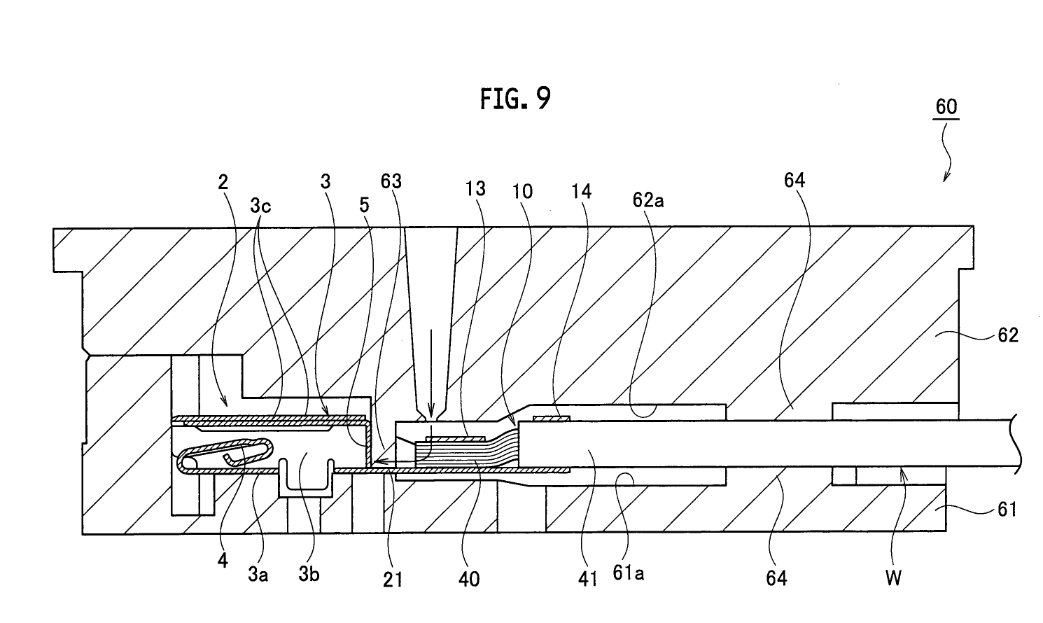

In the resin molding process, as illustrated in FIG. 9, the connection terminal 1 having the wire W connected thereto is set in the die 60 for resin molding. Next, molten resin is poured into cavities 61a, 61b inside the die 60, so that the resin covering part 30 is manufactured since the so-poured resin becomes solidified.

In resin molding, even when molten resin flows from a gap etc. between the insert die part 63 and the neck part 20 toward the terminal connection part 2, there is no possibility that the molten resin flows into the interior of the casing part 3 of the terminal connection part 2 since the molten resin is dammed up by the closing partition 5.

As mentioned above, the terminal connection part 2 is provided with the closing partition 5 which closes off the interior portion of the casing part 3 on side of the neck part 20. Therefore, when molding the resin covering part 30 with resin, the inflow of molten resin into the interior of the casing part 3 of the terminal connection part 2 is prevented by the closing partition 5. As above, when molding the resin covering part 30 with resin, there is no need of allowing the die 60 to prevent the inflow of molten resin into the terminal connection part 2, so that the positional management of the die 60 is facilitated. In connection, it is noted that the inflow of molten resin to the terminal connection part 2 side is also prevented by the insert die part 63 of the die 60 in the embodiment. Despite this fact, according to the embodiment, the inflow of molten resin into the interior of the casing part 3 could be prevented even when severe positional management of the die 60 is not performed, as mentioned above.

When molding the resin covering part 30, the wire W and the connection terminal 1 are maintained in their appropriate positions by the wire holding part 64 and the insert die part 63 serving as a terminal holding part and accordingly, it is possible to suppress bending deformation (bend-up) of the connection terminal 1. Again, as the insert die part 63 serves as the terminal holding part as well as an inflow-prevention part, it is possible to contemplate simplifying the constitution of the die.

### INDUSTRIAL APPLICABILITY

According to the present invention, it is possible to provide a connection terminal which eliminates the need of preventing the inflow of molten resin into a terminal connection part by a molding die in resin molding and which facilitates the positional management of the molding die, and also a manufacturing method of the connection terminal.

1. A connection terminal, comprising:
a terminal connection part having a casing part into which a mating terminal is to be inserted;
a wire connection part to which a wire is connected; and
a neck part which couples the terminal connection part and the wire connection part, wherein
a connection site between the wire connection part and the wire is covered with a resin covering part,
the terminal connection part is provided with a closing partition which closes off an interior of the casing part on the side of the neck part,
the neck part includes a bottom face wall and a pair of lateral face walls standing from either side of the bottom face wall, and
the pair of lateral face walls have parallel wall parts with a uniform spacing therebetween.

2. The connection terminal according to claim 1, wherein
the closing partition is provided by folding an inside top face wall, which is an inside one of two pieces of top face walls folded to overlap with each other, downwardly at a rear end of the inside top face wall.

3. A manufacturing method of manufacturing the connection terminal according to claim 1 or 2, wherein
getting an insert die part provided in the die to dam up resin into an inside of the pair of parallel wall parts when molding the resin covering part;
pouring resin into a cavity inside the die; and
forming the resin covering part by solidification of the poured resin.
